(19) United States
(12) Patent Application Publication
(10) Pub. No.: US 2017/0105422 A1
(43) Pub. Date: Apr. 20, 2017

(54) READY-TO-BAKE BROWNIE BATTERS AND METHODS OF PREPARING THE SAME

(71) Applicant: Continental Mills, Inc., Tukwila, WA (US)

(72) Inventors: Kelly Duffin-Maxwell, Tukwila, WA (US); Bart Bush, Tukwila, WA (US); Tony Wicke, Tukwila, WA (US); Yash Burgula, Tukwila, WA (US); Samina Van Winkle, Delray Beach, FL (US)

(21) Appl. No.: 15/293,801

(22) Filed: Oct. 14, 2016

Related U.S. Application Data
(60) Provisional application No. 62/241,565, filed on Oct. 14, 2015.

(51) Int. Cl. A21D 10/04; A23L 3/015; A21D 2/18

(52) U.S. Cl. CPC A21D 10/045; A21D 2/181; A23L 3/0155; A23V 2002/00

(57) ABSTRACT

A ready-to-bake brownie batter having prolonged shelf life and which produces brownies having desirable taste and texture characteristics is disclosed. The ready-to-bake brownie batter can include greater than or equal to 30 wt. % sugar, greater than or equal to 9 wt. % water, a sugar to flour ratio of greater than or equal to 1.5, and a water activity of from about 0.65 to about 0.85. Methods of preparing and packaging a ready-to-bake brownie batter using High Pressure Processing (HPP) is also disclosed.

### CROSS-REFERENCE TO RELATED APPLICATION(S)

This application claims priority to U.S. Provisional Patent Application No. 62/241,565, filed on Oct. 14, 2015, entitled READY-TO-BAKE BROWNIE BATTERS AND METHODS OF PREPARING THE SAME, which is hereby incorporated by reference in its entirety.

### TECHNICAL FIELD

This application relates to ready-to-bake (RTB) brownie batters that, when baked, produce brownies having taste and texture qualities that are pleasing to consumers and which have prolonged shelf stability. This application also relates to methods of preparing the RTB brownie batter described herein.

### BACKGROUND

Various ready-to-bake brownie batters have been available in the market over the past several decades. These RTB brownie batters have been made available in both refrigerated and frozen formats. RTB brownie batters provide consumers with the ability to purchase brownie batter that requires minimal preparation (e.g., preparing the oven, thawing the RTB brownie batter, and/or pouring the RTB brownie batter into a baking pan). The previously known RTB brownie batters were generally seen as more convenient than dry brownie mixes, which required the consumer to make measurements and mix ingredients such as eggs, oil, and water to the dry mix prior to the product being ready for baking.

Previously commercialized RTB brownie batters have enjoyed only limited success. This may be due to the need to the need for a thaw step (in the case of frozen batters), inadequate ambient shelf stability, and/or undesirable taste and/or texture as compared brownies made from scratch or from dry mixes.

Accordingly, a need currently exists for a RTB brownie batter that has prolonged shelf stability, makes baking brownies easy and convenient, and which produces brownies that are comparable in taste and texture to brownies prepared by other more conventional means.

### SUMMARY

Described herein are RTB brownie batters having prolonged shelf life and which makes baking brownies easy and convenient to prepare. The RTB brownie batters described herein also produce brownies that are desirable in taste and texture. In some embodiments, the RTB brownie batter includes greater than or equal to about 30 wt. % sugar, greater than or equal to about 9 wt. % water, and a sugar to flour ratio (S:F) of greater than or equal to about 1.5. The RTB brownie batter can also have a water activity (a_{w}) of from about 0.65 to about 0.85.

Also described herein are methods of preparing RTB brownie batters which help to improve the shelf life of the RTB brownie batters while reducing or eliminating adverse effects on the taste and texture qualities of the brownies produced from the RTB brownie batters. In some embodiments, a method of making a RTB brownie batter includes subjecting a mixture of ingredients to High Pressure Processing (HPP) in order to extend the shelf life of the RTB brownie batter while not sacrificing the taste and texture qualities of the brownies produced from the RTB brownie batter.

### BRIEF DESCRIPTION OF THE DRAWINGS

FIG. 1 is an illustration of a RTB brownie batter sealed in tub packaging according to some embodiments described herein.

FIG. 2 is an illustration of a RTB brownie batter sealed in chub packaging according to some embodiments described herein.

FIG. 3 is an illustration of RTB brownie batter sealed in tray packaging according to some embodiments described herein.

FIGS. 4a and 4b are illustrations of RTB brownie batter sealed in a pouch (with and without a spout).

### DETAILED DESCRIPTION

The present application is directed to ready-to-bake brownie batters. The term brownie as used herein should be construed to include a wide range of baked goods generally similar to brownies but which might be known by other names. For example, the term brownie as used herein should also be considered to encompass blondies.

The term ready-to-bake (RTB) as used herein refers to batters that generally do not require the addition of ingredients prior to being cooked in an oven, microwave, or other cooking device. The ready-to-bake brownie batters described herein generally have a viscous consistency as opposed to dry brownie mixes currently used in the market.

The RTB brownie batter described herein generally includes sugar, flour, and water in specified amounts and ratios. In some embodiments, the RTB brownie batter includes greater than or equal to about 30 wt. % sugar, greater than or equal to about 9 wt. % water, and a sugar to flour ratio (S:F) of greater than or equal to about 1.5. In some embodiments, the RTB brownie batter has a water activity (a_{w}) in the range of from about 0.65 to about 0.85. The RTB brownie batter may also include additional ingredients commonly used in brownie batters.

In some embodiments, the RTB brownie batter includes greater than or equal to about 30 wt. % sugar. In some embodiments, the sugar content of the RTB brownie batter is in the range of from about 30 wt. % to about 45 wt. %. In some embodiments, the sugar content of the RTB brownie batter is in the range of from about 32 wt. % to about 37 wt. %, such as about 35 wt. %. In some embodiments, the sugar content is in the range of from about 40 to about 45 wt. %. Sugar content within these ranges helps to provide the RTB brownie batter with a desirable taste while also helping to beneficially control (i.e., decrease) the water activity as discussed in greater detail below.

The sugar included in the RTB brownie batter can generally include any sugar that is suitable for use in baked goods. Exemplary sugar suitable for use in the RTB brownie batter includes, but is not limited to, mono-saccharides and di-saccharides such as xylose, arabinose, ribose, dextrose, galactose, mannose, fructose, sorbose, lactose, maltose, sucrose, high fructose corn syrup, high maltose corn syrup, molasses, brown sugar, and honey. Oligo-saccharides can also be used and include, but are not limited to, corn syrup and maltodextrin of various dextrose equivalents. Some low molecular weight resistant oligosaccharides such as fructo-oligosaccharides, arabinoxylo-oligosaccharides, xylo-oligosaccharides, galacto-oligosaccharides, and soluble corn fiber can also be sources of mono-saccharides and di-saccharides suitable for use in the RTB brownie batters. Additional ingredients provided in the RTB brownie batter can also provide sources of sugar, such as chocolate chips. The RTB brownie batter may include one or more different types of sugar.

In some embodiments, the RTB brownie batter includes from about 1 to about 20 wt. % flour. In some embodiments, the amount of flour used in the RTB brownie batter can be selected based on the amount of sugar used in the RTB brownie batter. For example, the amount of flour used in the RTB brownie batter can be selected based on maintaining a sugar to flour (S:F) ratio of greater than or equal to about 1.5. In some embodiments, the S:F ratio is in the range of from about 1.5 to about 3.5. In some embodiments, the S:F ratio is in the range of from about 2.0 to about 2.5. In some embodiments, the S:F ratio is in the range of from about 1.5 to about 2.0. In some embodiments, the S:F ratio is in the range of from about 2.5 to about 3.0. In some embodiments, the S:F ratio is about 2.0. A S:F ratio within these ranges helps to ensure that the brownies resulting from the RTB brownie batter have a desirable texture.

Any flour suitable for use in a brownie can be used in the RTB brownie batter. In some embodiments, the flour is selected based on the desired taste, texture, and appearance. Exemplary flours suitable for use in the RTB brownie batter include, but are not limited to, cereal grain flour, such as wheat flour (including soft wheat flour and pre-gelatinized flour). More than a single type of flour may be used in the RTB brownie batter.

In some embodiments, the RTB brownie batter includes greater than or equal to about 9 wt. % water. In some embodiments, the water content of the RTB brownie batter is in the range of from about 9 to about 30 wt. %. In some embodiments, the water content of the RTB brownie batter is in the range of from about 13 to about 25 wt. %. In some embodiments, the water content of the RTB brownie batter is in the range of from about 9 to about 16 wt. %. In some embodiments, the water content of the RTB brownie batter is in the range of from about 13 to about 15 wt. %. In some embodiments, the water content in the RTB brownie batter is in the range of from about 9 to about 10 wt. %. RTB brownie batters having water content within these ranges produce brownies having a desirable texture.

The water content of the RTB brownie batter is at least partially responsible for the RTB brownie batter having desirable texture, with a higher moisture content generally resulting in more desirable texture. However, a higher water content in the RTB brownie batter may also render the RTB brownie batter more susceptible to growth of yeasts and molds therein, which shortens the shelf life of the RTB brownie batter and makes the RTB brownie batter less safe for consumption. Accordingly, the RTB brownie batter disclosed herein is designed to provide a desirably high water content while also providing other ingredients in amounts aimed at suppressing the growth of molds and yeast in the RTB brownie batter.

For example, the RTB brownie batter described herein includes a sugar content in the range of from about 30 wt. % to about 45 wt. % as a means of counteracting the potentially negative effect of a relatively high water content in the RTB brownie batter. A sugar content greater than or equal to about 30 wt. % helps to reduce the water activity (a_{w}) of the RTB brownie batter, which consequently helps to suppress growth of yeasts and molds.

Water activity (a_{w}) is defined as a measure of the water vapor pressure generated by the product relative to the standard state partial vapor pressure of water, and can generally be calculated by dividing the moles of water plus the moles of soluble solids in the batter into the moles of water in the batter. Because sugar is a soluble solid, an increase in sugar content desirably decreases the water activity, but not at the expense of reducing the water content.

In some embodiments, the RTB brownie batter is designed to have an a_{w} in the range of from about 0.65 to about 0.85, and more preferably, in the range of from about 0.65 to about 0.70. In some embodiments, the a_{w} is in the range of from about 0.70 to about 0.75. In some embodiments, the a_{w} is in the range of from about 0.75 to about 0.80. In some embodiments, the a_{w} is in the range of from about 0.80 to about 0.85. In some embodiments, the a_{w} is in the range of from about 0.68 to about 0.69. Generally speaking, the RTB brownie batter composition is designed to reduce the a_{w}, since a higher water activity provides a more conducive environment for the growth of pathogenic organisms. Lowering the a_{w} provides the microbial stability required to impart prolonged shelf stability in the RTB brownie batter product under storage conditions. Sugar content is just one component of the RTB brownie batter that can be used to beneficially adjust the a_{w}, and other suitable manners of adjusting a_{w} can also be used.

The RTB brownie batter may include additional components typically used in brownie batter mixtures. In some embodiments, for example, the RTB brownie batter further includes one or more of shortening/oil (e.g., in the range of from 5 to 20 wt. %; for improving volume, grain, texture, mouthfeel and other organoleptic properties of final product), egg (contributes to structure of batter), butter, chocolate chips, cocoa powder, starch of various plant origins (to control rheological properties of the batter), gums/hydrocolloids (e.g., in the range of from 0 to 2.0 wt. %; to control rheological properties of the batter and to improve moisture content), antimycotic agents to improve microbial stability (e.g., in the range of from 0 to 2.5 wt. %), flavoring, milk solids, preservatives, gluten, spices, and flavor-identifying particulates (e.g., fruit, chocolate, nuts, candy, etc.). Exemplary shortening/oil that can be included in the RTB brownie batter include, but are not limited to, animal or vegetable based shortening and synthetic shortening or oils. Fats and fatty oils that may be found in butter, and the shortening include cottonseed oil, nut oil, soybean oil, sunflower oil, rapeseed oil, sesame oil, olive oil, and combinations thereof. Exemplary gums/hydrocolloids that can be used in the RTB brownie batter include, but are not limited to, xanthan gum, guar gum, locust bean gum, agar, carboxymethyl cellulose (CMC), and gum Arabic. Exemplary antimycotic agents that can be used in the RTB brownie batter include, but are not limited to, cultured dextrose, cultured whey, cultured skim milk, sorbic acid and its derivatives, propionic acid and its derivatives, vinegar, sodium diacetate, monocalcium phosphate, lactic acid, and citric acid. The antimycotic acid is typically present in the RTB brownie batter in an amount effective to inhibit growth of undesirable yeasts and/or molds.

In some embodiments, the RTB brownie batter is free of preservatives typically used in baked good consumer products. For example, the RTB brownie batter can be free of preservatives such as sorbic acid, potassium sorbate, propionic acid, calcium propionate, benzoic acid, sodium benzoate, sodium diacetate, and nisin. In other embodiments, the RTB brownie batter can include preservatives but in an amount less than has typically been used in the past in similar products. Eliminating or reducing the amount of preservatives in the RTB brownie batter can have a positive impact on, e.g., the taste of the product.

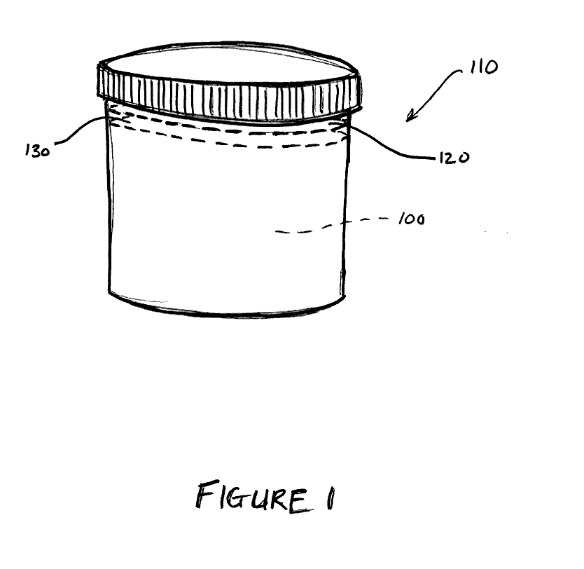

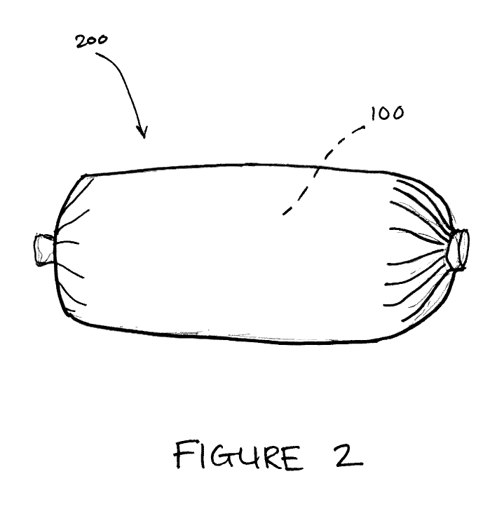

The RTB brownie batter described herein can be packaged in a variety of packages. In some embodiments and as shown in FIG. 1, the RTB brownie batter 100 is packaged in a resealable tub container 110. The tub packaging 110 can include a film 120 having low O₂, CO₂, and/or moisture permeability to help improve the shelf stability of the product. The head space 130 of the tub 110 can also be filled with CO₂/N₂ or ethanol vapor to further prolong shelf life. With reference to FIG. 2, the RTB brownie batter 100 can also be packaged in a chub 200 or other flexible packaging. In either of these packaging options, the RTB brownie batter is removed from the packaging and placed in a baking pan or the like prior to baking the RTB brownie batter.

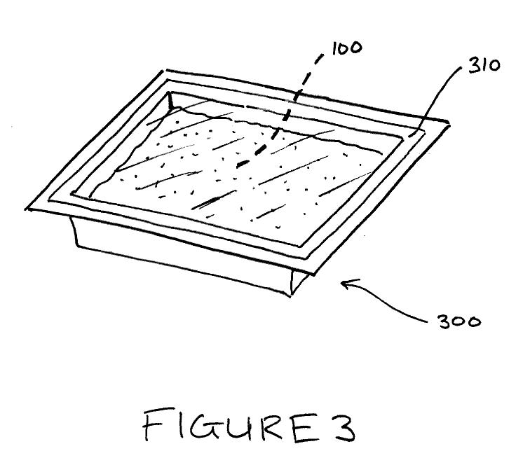

With reference to FIG. 3, the RTB brownie batter 100 can also be packaged in a tray 300 that is suitable for being placed directly into an oven or the like. The tray may be covered by a low permeability film 310 as described above. Similarly, any head space in the tray 300 can be filled with vapor as described above. In such packaging, there is no need to transfer the RTB brownie batter from the packaging to a baking tray prior to baking.

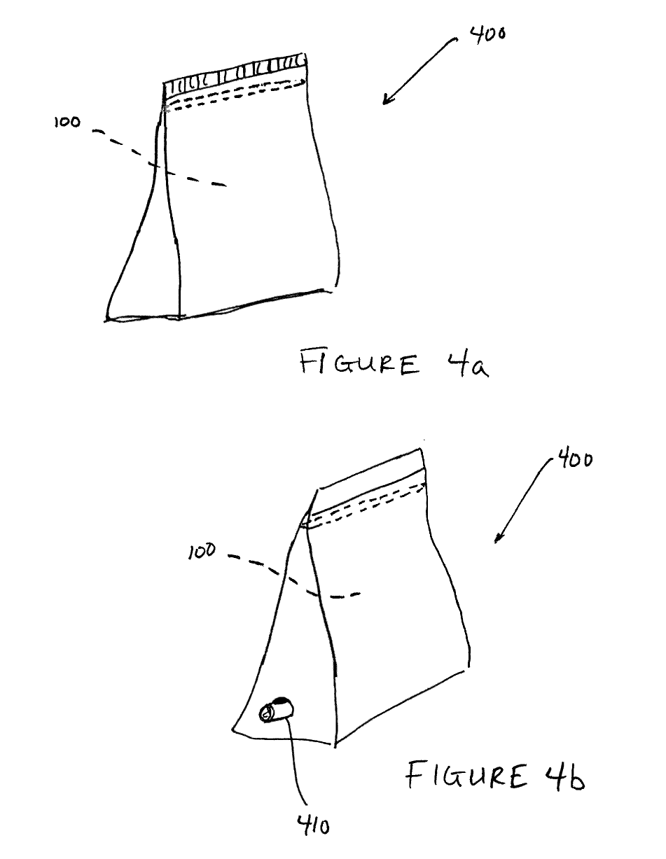

With reference to FIGS. 4a and 4b, the RTB brownie batter 100 can also be packaged in a pouch 400. In some embodiments, the pouch may be resealable. In FIG. 4b, the pouch includes a spout 410 which can be used to dispense RTB brownie batter 100 from the pouch 400. While FIG. 4b shows the spout 410 being located in a lower side portion of the pouch 400, the location of the spout 410 is generally not limited.

In some embodiments, the RTB brownie batter has a shelf stability in the range of greater than 1 month, greater than 2 months, greater than 3 months, greater than 4 months, greater than 5 months, greater than 6 months, greater than 7 months, greater than 8 months, greater than 9 months, greater than 10 months, greater than 11 months, or greater than 12 months. In some embodiments, the RTB brownie batter has a shelf stability of up to 18 months. The shelf stability refers to the useful life of the RTB brownie batter when stored in refrigerated conditions (e.g., about 32° F. to about 40° F.). During the useful shelf life of the RTB brownie batter, brownies prepared from the RTB brownie batter have desirable taste and texture qualities. Additionally, the taste and texture of brownies prepared from the RTB brownie batter do not noticeably deteriorate over the shelf life of the RTB brownie batter.

Methods of preparing a RTB brownie batter are also described herein. In some embodiments, such methods can generally include mixing together the ingredients of the RTB brownie batter, placing the RTB brownie batter in packaging, and subjecting the packaging to High Pressure Processing (HPP). HPP is a process that generally involves subjecting food products to a very high level of isostatic pressure in order to preserve and/or sterilize the food product. The process is typically carried out without the use of high temperatures in order to avoid the negative effects on food that can typically accompany high temperature processing.

Regarding the step of mixing the ingredients of the RTB brownie batter together, any suitable method for preparing the batter can be used. Generally speaking, the ingredients are placed together in a mixing bowl and mixed together for a period of time sufficient to provide a homogenous mixture of the ingredients. In some embodiments, one or more ingredients may be added at different times than others ingredients during the mixing step. In some embodiments, some ingredients may be mixed together to prepare one or more mixtures, which are then mixed together.

Following the preparation of the RTB brownie batter, the batter may be placed in the preferred packaging. Any of the packaging described above can be used, including those packaging types which provide low permeability films and or vapor in the head space. Other packaging not specifically described above can also be used.

Once packaged, the RTB brownie batter can generally be subjected to HPP. The intent of the HPP is to destroy yeast and mold and thereby prolong the shelf stability of the RTB brownie batter. One primary benefit of HPP is that it does not involve heating the packaged product, and therefore avoids the negative effect on taste and texture that heat treatment generally causes. Additionally, heating steps can undesirably alter ingredients in the RTB batter, such as chocolate chips. In a typical HPP process, the packaged product is subjected to a high level of isostatic pressure at cold or ambient temperatures (e.g., from about 34° F. to about 75° F.). The isostatic pressure is typically accomplished through high pressure water (or other liquid) pumped into a closed steel vessel in which the packaged product is sealed. Subjecting the packaged product to this level of pressure inactivates vegetative flora such as bacteria, virus, yeasts, molds and parasites. This results in extended shelf stability and improved food safety.

In some embodiments, the HPP process is carried out for in the range of from 3 to 4 minutes at a pressure in the range of from 5,000 to 6,000 bar. The total HPP process may take from about 7 to 9 minutes when including the time to increase and decrease the pressure before and after the 3 to 4 minute period when the pressure is held within the 5,000 to 6,000 bar range. In some embodiments, controlling the a_{w} to within the range of from about 0.65 to about 0.85 as discussed above allows the HPP process to be carried out for a shorter period of time. This in turn minimizes negative effects on the packaged product that might occur during HPP, such as the risk of bacterial spore activation.

In some embodiments, the RTB brownie batter need not be placed in its final packaging prior to HPP. In other words, the batter subjected to HPP can be transferred into final packaging after HPP has been carried out.

In some embodiments, the above methods of preparing the RTB brownie batter can eliminate the need for any type of acidification step that may typically be carried out on the RTB brownie batter.

The HPP steps discussed above can also be used for other packaged mixes and batters in order to extend the shelf life of the packaged products while limiting or eliminating the negative effects on the taste of the packaged products. Exemplary mixes and batters on which the HPP processing can be carried out include, but are not limited to pancake batter, waffle batter, muffin batter, and cookie batter.

### Example

A sample formulation of the RTB brownie batter according to embodiments described herein is prepared by mixing the ingredients in a mixer. Chocolate chips can be added during the last 15 seconds of mixing. In Table 1, all percentages are weight percentages based on the total weight of the batter.

TABLE 1
batter formula

| Ingredient | weight (%) |
|---|---|
| Liq. whole egg, pasteurized | 6-8 |
| water | 9-16 |
| sucrose | 30-40 |
| wheat flour | 10-20 |
| cocoa powder | 4-7 |
| soybean oil | 9-12 |
| bittersweet choc chips | 5-8 |
| salt | 0.1-0.8 |
| artificial flavor | 0-0.3 |
| baking soda | 0-0.10 |
| glycerol | 0-5 |
| 36DE corn syrup solids | 0-5 |
| gum Arabic | 0-1 |
| Pre-gelatinized wheat flour | 0-1 |
| Cultured dextrose | 0-2 |

The mixed batter is processed, poured or otherwise placed in an oven-ready-tray, and covered by a moisture and oxygen barrier foil. The refrigerated batter is baked at 325° F. for 45 minutes, and cooled at ambient temperature for 120 minutes before evaluation. The baked product is moist, fudge-like, sweet and with excellent chocolate taste.

From the foregoing, it will be appreciated that specific embodiments of the invention have been described herein for purposes of illustration, but that various modifications may be made without deviating from the scope of the invention. Accordingly, the invention is not limited except as by the appended claims.

We/I claim:

1. A ready-to-bake brownie batter comprising:
greater than or equal to 30 wt. % sugar;
greater than or equal to 9 wt. % water; and
flour;
wherein a sugar to flour (S:F) ratio of the ready-to-bake brownie batter is greater than or equal to 1.5 and a water activity of the ready-to-bake brownie batter is from about 0.65 to about 0.85.

2. The ready-to-bake brownie batter of claim 1, wherein the ready-to-bake brownie batter comprises from about 30 to about 45 wt. % sugar.

3. The ready-to-bake brownie batter of claim 2, wherein the ready-to-bake brownie batter comprises from about 40 to about 45 wt. % sugar.

4. The ready-to-bake brownie batter of claim 2, wherein the ready-to-bake brownie batter comprises from about 32 to about 37 wt. % sugar.

5. The ready-to-bake brownie batter of claim 4, wherein the ready-to-bake brownie batter comprises about 35 wt. % sugar.

6. The ready-to-bake brownie batter of claim 1, wherein the ready-to-bake brownie batter comprises from about 9 to about 30 wt. % water.

7. The ready-to-bake brownie batter of claim 6, wherein the ready-to-bake brownie batter comprises from about 13 to about 25 wt. % water.

8. The ready-to-bake brownie batter of claim 6, wherein the ready-to-bake brownie batter comprises from about 9 to about 16 wt. % water.

9. The ready-to-bake brownie batter of claim 7, wherein the ready-to-bake brownie batter comprises from about 13 to about 15 wt. % water.

10. The ready-to-bake brownie batter of claim 8, wherein the ready-to-bake brownie batter comprises from about 9 to about 10 wt. % water.

11. The ready-to-bake brownie batter of claim 1, wherein the S:F ratio is about 1.5 to about 3.5.

12. The ready-to-bake brownie batter of claim 11, wherein the S:F ratio is about 2.0 to about 2.5.

13. The ready-to-bake brownie batter of claim 12, wherein the S:F ratio is about 2.0.

14. The ready-to-bake brownie batter of claim 1, wherein the water activity is about 0.65 to about 0.70.

15. The ready-to-bake brownie batter of claim 14, wherein the water activity is about 0.68 to about 0.69.

16. The ready to bake brownie batter of claim 1, wherein the ready-to-bake brownie batter comprises from about 32 to about 37 wt. % sugar, from about 13 to about 15 wt. % water, and wherein the S:F ratio is about 2.0 and the water activity is from about 0.68 to 0.69.

17. A method of preparing and packaging a ready-to-bake brownie batter comprising:
mixing together sugar, water and flour to form a brownie batter;
placing the brownie batter in packaging; and
subjecting the packaging to High Pressure Processing (HPP).

18. The method of claim 17, wherein subjecting the packaging to HPP comprises subjecting the packaging to isostatic pressure in the range of from about 5,000 to about 6,000 bar for about 3 to about 4 minutes at ambient temperature or lower.

19. The method of claim 14, wherein mixing together sugar, water and flour comprises mixing together greater than or equal to about 30 wt. % sugar, greater than or equal to about 9 wt. % water, and an amount of flour such that the brownie batter has a sugar to flour ratio of greater than or equal to about 1.5.
